(19) United States
(12) Patent Application Publication
(10) Pub. No.: US 2026/0241572 A1
(43) Pub. Date: Aug. 20, 2026

(54) ROBOTS, SYSTEMS, COMPUTER PROGRAM PRODUCTS, AND METHODS FOR TRAINING FOUNDATION MODELS FOR OPERATION OF THE SAME

(71) Applicant: Sanctuary Cognitive Systems Corporation, Vancouver (CA)

(72) Inventors: James Gordon Wells, North Vancouver (CA); Mateusz Kownacki, Surrey (CA); Mani Ranjbar, Port Coquitlam (CA); Olivia Norton, North Vancouver (CA)

(21) Appl. No.: 19/536,407

(22) Filed: Feb. 11, 2026

Related U.S. Application Data
(60) Provisional application No. 63/758,473, filed on Feb. 14, 2025.

(51) Int. Cl. B25J 9/16

(52) U.S. Cl. CPC B25J 9/1689; B25J 9/163

(57) ABSTRACT

Robots, systems, methods, and computer program products for training models (e.g., foundation models) for controlling robots are described. Teleoperation data is collected for a human pilot controlling a robot by teleoperation to perform a task. The robot controlled by teleoperation may be either a real physical robot in the real physical world or a simulated robot in a virtual simulated world, or both. Human data is collected for humans performing the task. The teleoperation data and the human data are used to train a model (e.g., foundation model). The model can be used to control robots to perform the task autonomously without teleoperation.

### TECHNICAL FIELD

The present robots, computer program products, and methods generally relate to controlling operation of said robots and computer program products, and particularly relate to models (e.g., foundation models) that are capable of at least semi-autonomously controlling robot operation.

### DESCRIPTION OF THE RELATED ART

Robots are machines that may be deployed to perform work. Robots may come in a variety of different form factors, including humanoid form factors. Humanoid robots may be operated by tele-operation systems through which the robot is caused to emulate the physical actions of a human operator or pilot; however, such tele-operation systems typically require very elaborate and complicated interfaces comprising sophisticated sensors and equipment worn by or otherwise directed towards the pilot, thus requiring that the pilot devote their full attention to the tele-operation of the robot and limiting the overall accessibility of the technology.

Robots may be trained or otherwise programmed to operate semi-autonomously or fully autonomously. Training a robot typically involves causing the robot to repeatedly perform a physical task in the real world, which can cause significant wear and tear on the components of the robot before the robot can even be deployed to perform useful work in the field.

### BRIEF SUMMARY

According to a broad aspect, the present disclosure describes a method comprising: accessing at least one instance of teleoperation data, each instance of the at least one instance of teleoperation data comprising: pilot data, the pilot data collected by a first at least one sensor of a piloted teleoperation system where a pilot provides at least one input to cause a robot to perform a task; robot data, the robot data collected by a second at least one sensor of the robot and representing operation of the robot which performs the task; accessing at least one instance of human data, each instance of the at least one instance of human data comprising data collected by a third at least one sensor positioned at a human and representing the human performing the task; and training at least one model (e.g., foundation model) based on the at least one instance of teleoperation data and the at least one instance of human data.

Training at least one foundation model based on the at least one instance of teleoperation data and the at least one instance of human data may comprise: training a first foundation model based on the at least one instance of teleoperation data; and refining the first foundation model based on the at least one instance of human data to produce a second foundation model.

Training at least one foundation model based on the at least one instance of teleoperation data and the at least one instance of human data may comprise: training a first foundation model based on the at least one instance of human data; and refining the first foundation model based on the at least one instance of teleoperation data to produce a second foundation model.

Training at least one foundation model based on the at least one instance of teleoperation data and the at least one instance of human data may comprise: training a single foundation model based on the at least one instance of teleoperation data and the at least one instance of human data.

Accessing the at least one instance of teleoperation data may comprise, for each instance of the teleoperation data, capturing, by at least one image sensor of the second at least one sensor, at least a portion of the robot data as image data including a visual representation of the robot performing the task; and accessing the at least one instance of human data may comprise, for each instance of the human data, capturing, by at least one image sensor of the third at least one sensor, at least a portion of the human data as image data including a visual representation of the at least one human performing the task. Capturing at least a portion of the robot data as image data may comprise capturing robot-centric image data by the at least one image sensor of the second at least one sensor as worn by the robot and aligned with a perspective of the robot; and capturing at least a portion of the human data as image data may comprise capturing human-centric image data by the at least one image sensor of the third at least one sensor as worn by the human and aligned with a perspective of the at least one human.

Accessing the at least one instance of teleoperation data may comprise, for each instance of the teleoperation data, capturing, by at least one inertial sensor of the second at least one sensor, at least a portion of the robot data as inertial data including an inertial representation of the robot performing the task; and accessing the human data may comprise, for each instance of the human data, capturing, by at least one inertial sensor of the third at least one sensor, at least a portion of the human data as inertial data including an inertial representation of the human performing the task.

Accessing the at least one instance of teleoperation data may comprise, for each instance of the teleoperation data, capturing, by at least one haptic sensor of the second at least one sensor, at least a portion of the robot data as haptic data including a haptic representation of the robot performing the task; and accessing the at least one instance of human data may comprise, for each instance of the human data, capturing, by at least one haptic sensor of the third at least one sensor, at least a portion of the human data as haptic data including a haptic representation of the human performing the task.

Training the at least one foundation model may comprise training the at least one foundation model to include at least one action command which when executed cause a robot to attempt to perform the task.

Accessing the at least one instance of teleoperation data may comprise generating, by at least one processor, at least a portion of the robot data as simulated sensor data representing motion or physical contact of a simulated instance of the robot controlled in accordance with the pilot data to perform the task.

The at least one instance of teleoperation data may include a first quantity of instances; and the at least one instance of human data may include a second quantity of instances greater than the first quantity of instances.

For each instance of the at least one instance of teleoperation data, the robot data may represent operation of the robot which performs the task including engaging with a first set of at least one object; and for each instance of the at least one instance of human data, the human data may represent the human performing the task including engaging with a second set of at least one object which corresponds to the first set of at least one object. The first set of at least one object may be the second set of at least one object. The first set of at least one object may match the second set of at least one object. The method may further comprise accessing parameter data which specifies at least one parameter of each object of the first set of at least one object, training at least one foundation model based on the at least one instance of teleoperation data and the at least one instance of human data may comprise: training the at least one foundation model based on the at least one instance of teleoperation data, the at least one instance of human data, and the parameter data. Training the at least one foundation model based on the at least one instance of teleoperation data, the at least one instance of human data, and the parameter data may comprise: training a first foundation model based on the at least one instance of teleoperation data and the parameter data; and refining the first foundation model based on the at least one instance of human data and the parameter data to produce a second foundation model.

According to another broad aspect, the present disclosure describes a system comprising: at least one processor; and at least one non-transitory processor-readable storage medium communicatively coupled to the at least one processor, the at least on non-transitory processor-readable storage medium storing processor-executable instructions which, when executed by the at least one processor, cause the system to: access at least one instance of teleoperation data, each instance of the at least one instance of teleoperation data comprising: pilot data, the pilot data collected by a first at least one sensor of a piloted teleoperation system where a pilot provides at least one input to cause a robot to perform a task; robot data, the robot data collected by a second at least one sensor of the robot and representing operation of the robot which performs the task; access at least one instance of human data, each instance of the at least one instance of human data comprising data collected by a third at least one sensor positioned at a human and representing the human performing the task; and train, by the at least one processor, at least one model (e.g., foundation model) based on the at least one instance of teleoperation data and the at least one instance of human data.

The processor-executable instructions which cause the at least one processor to train at least one foundation model based on the at least one instance of teleoperation data and the at least one instance of human data may cause the at least one processor to: train a first foundation model based on the at least one instance of teleoperation data; and refine the first foundation model based on the at least one instance of human data to produce a second foundation model.

The processor-executable instructions which cause the at least one processor to train at least one foundation model based on the at least one instance of teleoperation data and the at least one instance of human data may cause the at least one processor to: train a first foundation model based on the at least one instance of human data; and refine the first foundation model based on the at least one instance of teleoperation data to produce a second foundation model.

The processor-executable instructions which cause the at least one processor to train at least one foundation model based on the at least one instance of teleoperation data and the at least one instance of human data may cause the at least one processor to: train a single foundation model based on the at least one instance of teleoperation data and the at least one instance of human data.

The system may further comprise: at least one image sensor of the second at least one sensor: and at least one image sensor of the third at least one sensor. The processor-executable instructions which cause the system to access the at least one instance of teleoperation data may cause the at least one image sensor of the second at least one sensor to capture at least a portion of the robot data as image data including a visual representation of the robot performing the task; and the processor-executable instructions which cause the system to access the at least one instance of human data may cause the at least one image sensor of the third at least one sensor to capture at least a portion of the at least one instance of human data as image data including a visual representation of the human performing the task. The at least one image sensor of the second at least one sensor may be arranged to capture robot-centric image data as a sensor worn by the robot and aligned with a perspective of the robot; and the at least one image sensor of the third at least one sensor may be arranged to capture human-centric image data as worn by the human and aligned with a perspective of the at least one human.

The system may further comprise: at least one inertial sensor of the second at least one sensor: and at least one inertial sensor of the third at least one sensor. The processor-executable instructions which cause the system to access the at least one instance of teleoperation data may cause the at least one inertial sensor of the second at least one sensor to capture at least a portion of the robot data as inertial data including an inertial representation of the robot performing the task; and the processor-executable instructions which cause the system to access the at least one instance of human data may cause the at least one inertial sensor of the third at least one sensor to capture at least a portion of the at least one instance of human data as inertial data including an inertial representation of the human performing the task.

The system may further comprise: at least one haptic sensor of the second at least one sensor: and at least one haptic sensor of the third at least one sensor. The processor-executable instructions which cause the system to access the at least one instance of teleoperation data may cause the at least one haptic sensor of the second at least one sensor to capture at least a portion of the robot data as haptic data including a haptic representation of the robot performing the task; and the processor-executable instructions which cause the system to access the at least one instance of human data may cause the at least one haptic sensor of the third at least one sensor to capture at least a portion of the at least one instance of human data as haptic data including a haptic representation of the human performing the task.

The processor-executable instructions which cause the at least one processor to train the at least one foundation model may cause the at least one processor to train the at least one foundation model to include at least one action command which when executed causes a robot to attempt to perform the task.

The processor-executable instructions which cause the system to access the at least one instance of teleoperation data may cause the at least one processor to generate at least a portion of the robot data as simulated sensor data representing motion or physical contact of a simulated instance of the robot controlled in accordance with the pilot data to perform the task.

The at least one instance of teleoperation data may include a first quantity of instances; and the at least one instance of human data may include a second quantity of instances greater than the first quantity of instances.

For each instance of the at least one instance of teleoperation data, the robot data may represent operation of the robot which performs the task including engaging with a first set of at least one object; and for each instance of the at least one instance of human data, the human data may represent the human performing the task including engaging with a second set of at least one object which corresponds to the first set of at least one object. The first set of at least one object may be the second set of at least one object. The first set of at least one object may match the second set of at least one object. The processor-executable instructions may further cause the system to access parameter data which specifies at least one parameter of each object of the first set of at least one object; the processor-executable instructions which cause the at least one processor to train at least one foundation model based on the at least one instance of teleoperation data and the at least one instance of human data may cause the at least one processor to: train the at least one foundation model based on the at least one instance of teleoperation data, the at least one instance of human data, and the parameter data. The processor executable instructions which cause the at least one processor to train the at least one foundation model based on the at least one instance of teleoperation data, the at least one instance of human data, and the parameter data may cause the at least one processor to: train a first foundation model based on the at least one instance of teleoperation data and the parameter data; and refine the first foundation model based on the at least one instance of human data and the parameter data to produce a second foundation model.

According to yet another broad aspect, the present disclosure describes a computer program product comprising at least one non-transitory processor-readable storage medium storing processor-executable instructions or data that, when executed by at least one processor of a processor-based system, cause the processor-based system to: access at least one instance of teleoperation data, each instance of the at least one instance of teleoperation data comprising: pilot data, the pilot data collected by a first at least one sensor of a piloted teleoperation system where a pilot provides at least one input to cause a robot to perform a task; robot data, the robot data collected by a second at least one sensor of the robot and representing operation of the robot which performs the task; access at least one instance of human data, each instance of the at least one instance of human data comprising data collected by a third at least one sensor positioned at a human and representing the human performing the task; and train, by the at least one processor, at least one model (e.g., foundation model) based on the at least one instance of teleoperation data and the at least one instance of human data.

The processor-executable instructions or data which cause the at least one processor to train at least one foundation model based on the at least one instance of teleoperation data and the at least one instance of human data may cause the at least one processor to: train a first foundation model based on the at least one instance of teleoperation data; and refine the first foundation model based on the at least one instance of human data to produce a second foundation model.

The processor-executable instructions or data which cause the at least one processor to train at least one foundation model based on the at least one instance of teleoperation data and the at least one instance of human data may cause the at least one processor to: train a first foundation model based on the at least one instance of human data; and refine the first foundation model based on the at least one instance of teleoperation data to produce a second foundation model.

The processor-executable instructions or data which cause the at least one processor to train at least one foundation model based on the at least one instance of teleoperation data and the at least one instance of human data may cause the at least one processor to: train a single foundation model based on the at least one instance of teleoperation data and the at least one instance of human data.

The processor-executable instructions or data which cause the system to access the at least one instance of teleoperation data may cause the system to, for each instance of the teleoperation data, capture, by at least one image sensor of the second at least one sensor, at least a portion of the robot data as image data including a visual representation of the robot performing the task; and the processor-executable instructions or data which cause the system to access the at least one instance of human data may cause the system to, for each instance of the human data, capture, by at least one image sensor of the third at least one sensor, at least a portion of the human data as image data including a visual representation of the at least one human performing the task. The processor-executable instructions or data which cause the system to capture at least a portion of the robot data as image data may cause the system to capture robot-centric image data by the at least one image sensor of the second at least one sensor as worn by the robot and aligned with a perspective of the robot; and the processor-executable instructions or data which cause the system to capture at least a portion of the human data as image data may cause the system to capture human-centric image data by the at least one image sensor of the third at least one sensor as worn by the human and aligned with a perspective of the at least one human.

The processor-executable instructions or data which cause the system to access the at least one instance of teleoperation data may cause the system to, for each instance of the teleoperation data, capture, by at least one inertial sensor of the second at least one sensor, at least a portion of the robot data as inertial data including an inertial representation of the robot performing the task; and the processor-executable instructions or data which cause the system to access the human data may cause the system to, for each instance of the human data, capture, by at least one inertial sensor of the third at least one sensor, at least a portion of the human data as inertial data including an inertial representation of the human performing the task.

The processor-executable instructions or data which cause the system to access the at least one instance of teleoperation data may cause the system to, for each instance of the teleoperation data, capture, by at least one haptic sensor of the second at least one sensor, at least a portion of the robot data as haptic data including a haptic representation of the robot performing the task; and the processor-executable instructions or data which cause the system to access the at least one instance of human data may cause the system to, for each instance of the human data, capture, by at least one haptic sensor of the third at least one sensor, at least a portion of the human data as haptic data including a haptic representation of the human performing the task.

The processor-executable instructions or data which cause the at least one processor to train the at least one foundation model may cause the at least one processor to train the at least one foundation model to include at least one action command which when executed causes a robot to attempt to perform the task.

The processor-executable instructions or data which cause the system to access the at least one instance of teleoperation data may cause the at least one processor to generate at least a portion of the robot data as simulated sensor data representing motion or physical contact of a simulated instance of the robot controlled in accordance with the pilot data to perform the task.

The at least one instance of teleoperation data may include a first quantity of instances; and the at least one instance of human data may include a second quantity of instances greater than the first quantity of instances.

For each instance of the at least one instance of teleoperation data, the robot data may represent operation of the robot which performs the task including engaging with a first set of at least one object; and for each instance of the at least one instance of human data, the human data may represent the human performing the task including engaging with a second set of at least one object which corresponds to the first set of at least one object. The first set of at least one object may be the second set of at least one object. The first set of at least one object may match the second set of at least one object. The processor-executable instructions or data may further cause the system to access parameter data which specifies at least one parameter of each object of the first set of at least one object; the processor-executable instructions or data which cause the at least one processor to train at least one foundation model based on the at least one instance of teleoperation data and the at least one instance of human data may cause the at least one processor to: train the at least one foundation model based on the at least one instance of teleoperation data, the at least one instance of human data, and the parameter data. The processor executable instructions or data which cause the at least one processor to train the at least one foundation model based on the at least one instance of teleoperation data, the at least one instance of human data, and the parameter data may cause the at least one processor to: train a first foundation model based on the at least one instance of teleoperation data and the parameter data; and refine the first foundation model based on the at least one instance of human data and the parameter data to produce a second foundation model.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is an illustrative diagram of an exemplary robot system comprising various features and components described throughout the present robots, systems, methods, and computer program products.

FIGS. 2A and 2B are illustrative diagrams of exemplary systems for collecting human data for the present robots, systems, methods, and computer program products.

FIG. 3 is a schematic diagram of an exemplary system for collecting teleoperation data and human data in accordance with the present robots, systems, computer program products, and methods.

FIG. 4 is a flow diagram showing an exemplary method of training a model (e.g., foundation model) in accordance with the present robots, systems, computer program products, and methods.

FIG. 5 is an illustrative diagram showing an exemplary simulated environment in which robot data is collected in accordance with the present robots, systems, computer program products, and methods.

FIG. 6 is an illustrative diagram showing collection of human data for a plurality of humans in accordance with the present robots, systems, computer program products, and methods.

FIG. 7 is an illustrative diagram of ego-centric image data for a robot in accordance with the present robots, systems, computer program products, and methods.

FIG. 8 is an illustrative diagram of ego-centric image data for a human in accordance with the present robots, systems, computer program products, and methods.

### DETAILED DESCRIPTION

The following description sets forth specific details in order to illustrate and provide an understanding of the various implementations and embodiments of the present robots, systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present robots, systems, computer program products, and methods.

A general-purpose robot is able to complete multiple different work objectives. As used throughout this specification and the appended claims, the term “work objective” refers to a particular task, job, assignment, or application that has a specified goal and a determinable outcome, often (though not necessarily) in the furtherance of some economically valuable work. Work objectives exist in many aspects of business, research and development, commercial endeavors, and personal activities. Exemplary work objectives include, without limitation: cleaning a location (e.g., a bathroom) or an object (e.g., a bathroom mirror), preparing a meal, loading/unloading a storage container (e.g., a truck), taking inventory, collecting one or more sample(s), making one or more measurement(s), building or assembling an object, destroying or disassembling an object, delivering an item, harvesting objects and/or data, and so on. The various implementations described herein provide robots, systems, computer program products, and methods for initializing, configuring, or training at least one model for a robot to at least semi-autonomously complete at least one work objective or task.

In particular, to enable a general purpose robot to carry out tasks and perform work objectives, at least one foundation model may be trained. The at least one foundation model acts a control paradigm which helps control actions of a robot based on sensor data for the robot. A foundation model generally refers to a machine learning or deep learning model trained on a large corpus of data, so that it can be applied across a wide range of use cases. However, throughout this specification, unless the specific context requires otherwise the terms “model” and “foundation model” are used interchangeably in an exemplary sense to generally refer to any machine learning model or control policy (i.e., general-purpose, task-specific, or otherwise) that, when executed by at least one processor of a robot control system, causes the corresponding robot to at least semi-autonomously perform at least one work objective or task.

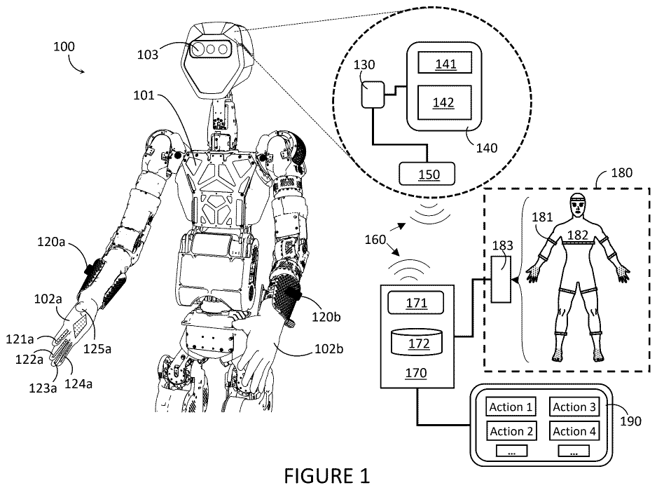

At least one foundation model is trained based on a large corpus of data. As an example, teleoperation data can be obtained from a teleoperation system, whereby a human pilot performs operations which are captured by the teleoperation system and used to control operation of the robot (discussed in detail with reference to FIG. 1).

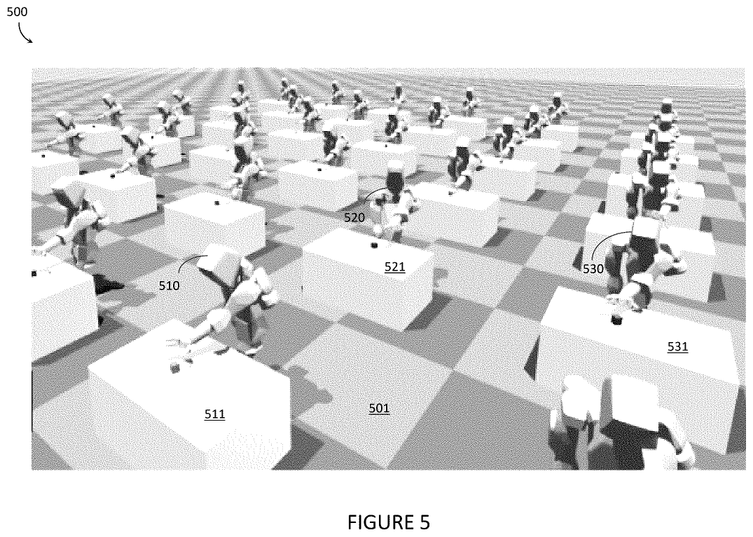

Teleoperation data that is used to train the foundation model is called “egocentric” because it is from the perspective of the robot/pilot. A vast amount of egocentric data is needed to accurately train the at least one foundation model, and it is very difficult to collect this quantity of data via teleoperation. It is very time consuming and expensive to collect egocentric data from real-world teleoperated robots, at least because there are a limited number of robots, the robots are expensive, the robots have limited up-time before needing repair, and 1:1 pilot to robot teleoperation takes a lot of human time, etc. To more efficiently capture training data, training data can be collected in simulation (a human pilot can control operation of a simulated robot, as discussed later with reference to FIG. 5). This addresses some of the above issues and is less expensive, but still requires significant pilot time and thus is still time consuming and expensive.

Whether the robot is in the real-world or simulated, the pilot providing the teleoperation input Is performing real world labor (which consumes time and money), but this real world labor is typically directed towards “toy” tasks that achieve or produce nothing of value other than the data.

It is an objective of the present invention to enable collection of vast amounts of data for foundation model generation and training, while reducing the expense of teleoperation collection, and/or to collect the training data during otherwise productive activities (real-world productivity is achieved beyond just the collection of training data).

In accordance with the present robots, systems, computer program products, and methods, data is captured from multiple sources, including robots and humans performing analogous tasks.

As stated previously, the various implementations described herein provide robots, systems, computer program products, and methods where at least one foundation model is trained to enable a robot to at least semi-autonomously complete a task. Unless the specific context requires otherwise, the term “autonomously” is used throughout this specification and the appended claims to mean “without control by another party” and the term “semi-autonomously” is used to mean “at least partially autonomously.” In other words, throughout this specification and the appended claims, the term “semi-autonomously” means “with limited control by another party” unless the specific context requires otherwise. An example of a semi-autonomous robot is one that can independently and/or automatically execute and control some of its own low-level functions, such as its mobility and gripping functions, but relies on some external control for high-level instructions such as what to do and/or how to do it.

FIG. 1 is an illustrative diagram of an exemplary robot system 100 comprising various features and components described throughout the present methods, systems, computer program products, and devices. Robot system 100 comprises a robot body 101 with a first physically actuatable component 102a and a second physically actuatable component 102b mechanically coupled to body 101. In the illustrated implementation, first and second physically actuatable components 102a and 102b each correspond to a respective robotic hand. Robotic hand 102a emulates a human hand and includes multiple fingers 121a, 122a, 123a, and 124a and an opposable thumb 125a. Robotic hand 102b is similar to a mirror-image of robotic hand 102a while corresponding details are not labeled for robotic hand 102b to reduce clutter. First and second physically actuatable components 102a and 102b do not necessarily have to exactly mimic human anatomy (hands), but could be approximations such as grippers or other end effector types. Robotic hands 102a and 102b may be physically actuatable by a variety of different means, including electromechanical actuation, cable-driven actuation, magnetorheological fluid-based actuation, and/or hydraulic actuation. Some exemplary details of actuation technology that may be employed to physically actuate robotic hands 102a and 102b are described in U.S. patent application Ser. No. 17/491,577 and U.S. Provisional Patent Application Ser. No. 63/191,732, filed May 21, 2021 and entitled “Systems, Devices, And Methods For A Hydraulic Robotic Arm”, both of which are incorporated by reference herein in their entirety. Robot hand 102a is shown with textured areas which represent at least one haptic sensor. Due to the perspective of FIG. 1, haptic sensors are not visible on robotic hand 102b, but similar haptic sensors can be included on robotic hand 102b.

Robot body 101 further includes at least one sensor 103 that detects and/or collects data about the environment and/or objects in the environment of robot system 100. In the illustrated implementation, sensor 103 corresponds to a sensor system including at least one image sensor (camera), a microphone, and an inertial measurement unit that itself comprises three orthogonal accelerometers, a magnetometer, and a compass, though in other implementations any appropriate type of sensor could be included. Robot body 101 is also shown as including inertial sensor 120a on first physically actuatable component 102a, and inertial sensor 120b on second physically actuatable component 102b. Inertial sensors 120a and 120b can capture respective inertial data representing movement of respective physically actuatable components 102a and 102b. Data pertaining to the robot, as captured by at least one sensor at the robot (such as the at least one sensor 103, the inertial sensors 120a and 120b, or other sensors such as haptic sensors or inertial sensors positioned in actuatable components 102a and 102b), can be referred to throughout this disclosure as “robot data”. Such robot data represents the experience of the robot as it goes through any actions or tasks.

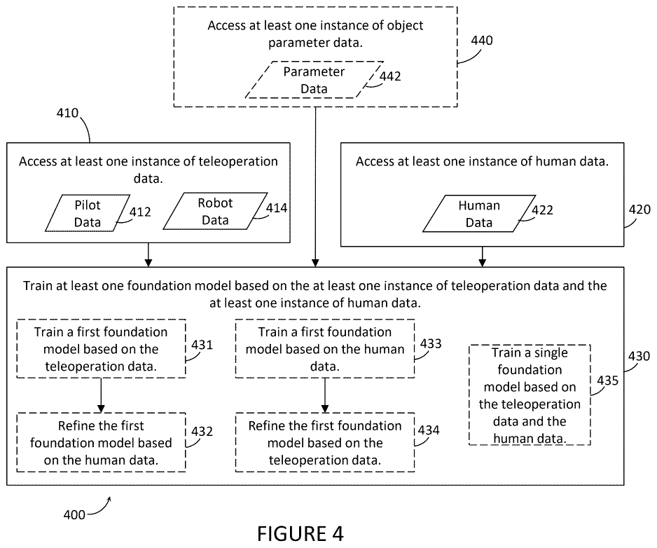

For the purposes of illustration, FIG. 1 includes details of certain exemplary components that are carried by or within robot body 101 in accordance with the present robots, systems, methods, computer program products, and devices. Such components include at least one processor 130 and at least one non-transitory processor-readable storage medium, or “memory”, 140 communicatively coupled to processor 130. When robot system 100 is operating in an autonomous or semi-autonomous mode, memory 140 stores at least one foundation model (trained as discussed later with reference to FIG. 4), when executed or applied by processor 130, causes robot body 101 (including applicable actuatable components such as either or both of robotics hands 102a and/or 102b) to perform at least one specified task.

When operated in a teleoperation mode, processor 130 is also communicatively coupled to a wireless transceiver 150 via which robot body 101 sends and receives wireless communication signals 160 with an exemplary teleoperation system 170. To this end, teleoperation system 170 also includes a wireless transceiver 171.

In the illustrated example, teleoperation system 170 includes a low-level teleoperation interface 180. Low-level teleoperation interface 180 includes a sensor system 181 that detects real physical actions performed by a human pilot 182 and a processing system 183 that converts such real physical actions into low-level teleoperation instructions that, when executed by processor 130, cause robot body 101 (and any applicable actuatable components such as hands 102a and/or 102b) to emulate the physical actions performed by pilot 182. In some implementations, sensor system 181 may include many sensory components typically employed in the field of virtual reality games, such as haptic gloves, accelerometer-based sensors worn on the body of pilot 182, and a VR headset that enables pilot 182 to see optical data collected by sensor 103 of robot body 101. The data collected by any of the above sensors which captures movement of the human pilot is referred to herein as “pilot data”.

Teleoperation system 170 is also shown as including at least one non-transitory processor-readable storage medium (memory) 172, which optionally stores teleoperation data (pilot data and/or robot data). Teleoperation system 170 can be implemented in a distributed manner. For example, memory 172 can be at a server location remote from low-level teleoperation interface 180.

Robot system 100 in FIG. 1 is illustrated such that the robot generally emulates or mimics human anatomy. However, this is not necessarily the case, and any appropriate form of robot could be used. In some implementations, a robot may only partially emulate human anatomy (e.g. the robot may only include a limited subset of human-like features). As an example, a robot may not have human-like legs, but may instead rely on other forms of locomotion (such as wheels), or may be stationary.

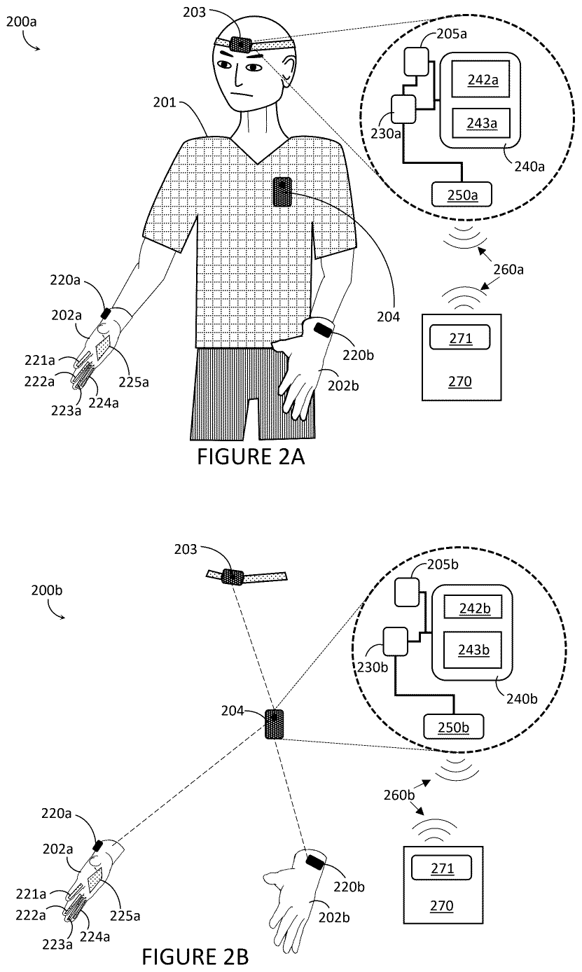

FIG. 2A is an illustrative diagram of an exemplary system 200a comprising various features and components worn by a human 201, as used with the present systems, methods, computer program products, and devices. In particular, FIG. 2A illustrates a variety of sensors which can be worn by human 201, useful for collecting human data used to train or refine a foundation model as discussed later with reference to FIG. 4. Throughout this disclosure, “human data” generally refers to data which represents at least one human (e.g. data representing movement or action of a human to perform a task). The sensors worn by human 201 are “egocentric”, in that the data captured is from the perspective of the human 201. That is, the sensors worn by the human 201 capture data which represents or approximates what human 201 experiences (e.g. sees or feels).

FIG. 2A illustrates exemplary image capture devices 203 and 204 worn by the human 201. Each of image capture devices 203 and 204 include at least one image sensor which captures image data. Image capture device 203 is worn on a head of human 201 (e.g. by being affixed to headgear such as a headband, hat, or helmet). Image capture device 203 is positioned close to the eyes of human 201, and oriented to capture image data which represents what human 201 sees. Because image capture device 203 is positioned on a head of the human 201, image capture device 203 will move along with the head, and thus closely capture what the human 201 sees. Image capture device 204 is worn on a torso of human 201 (e.g. affixed to clothing or affixed to a strap or harness worn by human 201). Image capture device 204 will not move along with a head of the user like image capture device 203, and thus image data captured by image capture device 204 may not represent what human 201 sees as well as image data from image capture device 203 does. However, wearing an image capture device on the torso can be more comfortable and more stable for human 201, and thus may be preferred in some implementations.

Further in the illustrated example, system 200 comprises sensors positioned at respective hands of the human 201. In particular, a first glove 202a is worn on a right hand of the human 201, and a second glove 202b is worn on the left hand of the human 201. First glove 202a and/or second glove 202b can include a variety of sensors.

In the illustrated example, first glove 202a has an inertial sensor 220a thereon, and second glove has an inertial sensor 220b thereon. Inertial sensors 220a and 220b can include any appropriate variety of sensors, such as accelerometers, gyroscopes, or inertial measurement units (IMUs). The inertial sensors 220a and 220b capture inertial data at least partially representing the human 201 performing an action or task. For example, inertial sensors 202a and 202b can capture inertial data representing movement of the hands and/or arms of human 201 as the human 201 performs an action or task. While FIG. 2A illustrates two inertial sensors, one proximate each hand of the user, any appropriate number of inertial sensors can be worn by the human 201 in any appropriate location. As non-limiting examples, inertial sensors could be positioned at any or all of hands, wrists, forearms, elbows, upper arms, shoulders, torso, neck, head, waist, legs, or feet of human 201. Further, the inclusion of inertial sensors is optional, and in some implementations human 201 may not be equipped with any inertial sensors.

Also in the illustrated example, first glove 202a has haptic sensors thereon. In the example, haptic sensors 221a, 222a, 223a, and 224a are positioned on fingers of the glove 202a. Further haptic sensor 225a is positioned on a palm of glove 202a. Due to the perspective of FIG. 2A, haptic sensors are not shown on glove 202b, but similar haptic sensors can be included on glove 202b. The haptic sensors can collect haptic data at least partially representing human 201 performing an action or task (e.g. haptic data representing human 201 touching or applying force to an object). Further, while FIG. 2A illustrates discrete haptic sensors located on hands of the human 201, haptic sensors can take any appropriate form (such as a large haptic area covering the entire inner surface of the hand, or many discrete regions over the hand). Further, haptic sensors can be located on other portions of the body of human 201, such as any or all of hands, wrists, forearms, elbows, upper arms, shoulders, torso, neck, head, waist, legs, or feet. Further, the inclusion of haptic sensors is optional, and in some implementations human 201 may not be equipped with any haptic sensors.

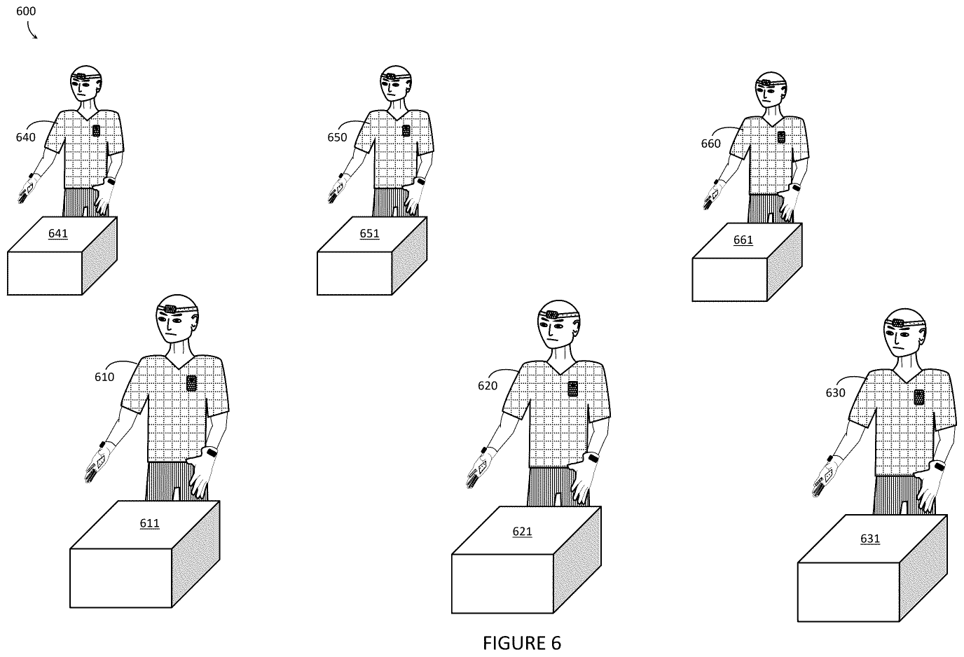

The inclusion of at least one image sensor (examples shown as image capture devices 203 and 204) is optional, and captured human data does not necessarily need to include image data. However, image data is a particularly useful form of human data to capture, and thus most implementations will include an image sensor such as the examples of image capture devices 203 and 204. As an example, gloves 202a and 202b can be bulky, uncomfortable, restrictive, or otherwise impede natural dexterity. As discussed in detail later with reference to FIG. 6, human 201 is expected to perform tasks and be productive while wearing sensors such as shown in FIG. 2A. Gloves or other cumbersome equipment may impede this productivity, and may cause discomfort, strain, or frustration to human 201. Further, cumbersome equipment can also affect the quality of collected data. For example, if the equipment forces the human to move in unnatural ways, the collected data will capture such unnatural movement. Conversely, an image sensor does need impede hand motions of the human, and may in some circumstances be affixed to existing equipment worn by the human (e.g. a shirt or safety helmet), thus having minimal impact on the human's comfort and movement.

In view of the above, it is desirable to minimize the size and weight, and optimize the form factor, of any equipment worn by humans, to reduce burden on the humans and to capture high-quality data.

For the purposes of illustration, FIG. 2A includes details of certain exemplary components that are carried by or within devices or components worn by human 201. Such components include at least one image sensor 205a, at least one processor 230a, at least one non-transitory processor-readable storage medium, or “memory”, 240a communicatively coupled to the at least one processor 230a, and a communication interface 250a. These components are illustrated as being part of image capture device 203, but similar components could be included in any of the devices worn by human 201, such as image capture device 204 or gloves 202a or 202b.

Memory 240a stores at least processor-executable instructions 242a that, when executed by the at least one processor 230a, cause the component (image capture device 203 in the illustrated example) to carry out operations for capturing data. In the Illustrated example, this could entail causing the image sensor 205a to be powered and capture image data, causing the processor 230a to perform operations on the image data (such as formatting, compression, etc.), causing the memory 240 to store the image data (shown as 243a), and/or causing the communication interface 250a to transmit the image data. These operations are merely an exemplary list, and other operations could be stored as processor-executable instructions in medium 240a. Further, not all of the exemplary operations need to be performed in all implementations. For example, in some implementations the image data could be transmitted by communication interface 250a without processing by the at least one processor 230a, and/or without storage by medium 240a.

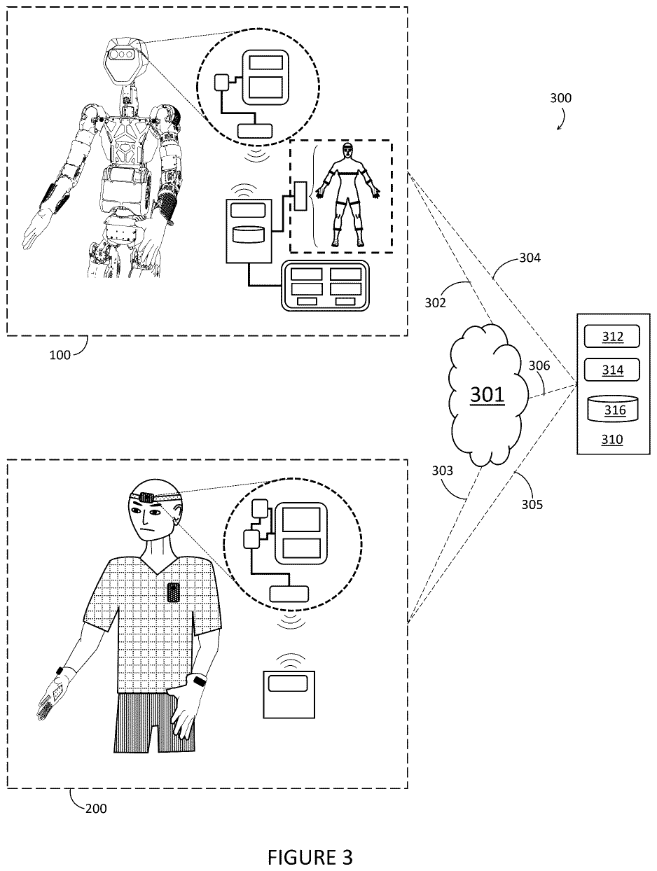

In the illustrated example, communication interface 250a is a wireless transceiver via which the captured data (image data in the example) is transmitted as wireless communication signals 260a to an exemplary management device 270. To this end, management device 270 also includes communication interface 271 (shown as a wireless transceiver). Management device 270 can aggregate data from multiple sources (including multiple sources of human data, and multiple sources or robot and/or pilot data), as discussed with reference to FIG. 3 later.

In the example of FIG. 2A, any of the illustrated components or devices worn by the human 201 can include a sensor, processor, medium, and communication interface similar to as shown for image capture device 203. In this regard, each of the components or devices in FIG. 2A can capture respective data and communicate independently with management device 270. However, this is not required, as shown by the example in FIG. 2B discussed below.

FIG. 2B is an illustrative diagram of an exemplary system 200b comprising various features and components worn by a human. System 200b in FIG. 2B is similar to system 200a in FIG. 2A, and the description of FIG. 2A generally applies to FIG. 2B unless context dictates otherwise. In particular, FIG. 2B illustrates a variety of components, devices, and sensors which are shown in FIG. 2A and discussed above. The discussion of elements in FIG. 2A applies to elements with the same reference numerals in FIG. 2B.

FIG. 2B omits illustration of human 201 to reduce clutter, but otherwise illustrates the same sensors and components worn by the human 201 in FIG. 2A. FIG. 2B illustrates an implementation where multiple devices can communicate data to a single device worn by the human, which in turn transmits the data from the human to a separate device. In the illustrated example, image capture device 203, inertial devices 220a and 220b, and haptic sensors 221a, 222a, 223a, 224a, and 225a transmit respectively captured image data, inertial data, and haptic data to image capture device 204. In the illustrated example, image capture device 204 includes an image sensor 205b, at least one processor 230b, a memory 240b (which stores processor-executable instructions 242b and captured data 243b), and a communication interface 250b. These elements are similar, respectively, to image sensor 205a, at least one processor 230a, memory 240a (which stores processor-executable instructions 242a and captured data 243a), and communication interface 250a illustrated in FIG. 2A, and the description of the elements in FIG. 2A also applies to the similar elements in FIG. 2B.

In the example of FIG. 2B, captured data from the other sensors and devices is received by image capture device 204, and is in turn transmitted from image capture device 204 to management device 270 as signals 260b via communication interface 250b. Optionally, the captured data can be processed (e.g. formatted or compressed) by the at least one processor 230b, and/or stored at the medium 240b (shown as 243b). In this way, image capture device 204 acts as a central data collection device at the human, and the other devices can communicate therewith by any appropriate communication hardware (e.g. wires or wireless).

While image capture device 204 is illustrated in FIG. 2B as acting as the central data collection device, any other device could fulfill this purpose, such as image capture device 203, components attached to glove 202a or glove 202b, or any other appropriate device positioned at or worn by the human. Further, the data collection device itself does not need to include a data sensor. In the example of FIG. 2B, sensor 205b could be omitted from image capture device 204, such that image capture device 204 would act as a data collection device which receives captured data from other devices but itself does not capture data.

In some implementations, select devices worn by the human may communicate directly with a management device, whereas other devices may provide data to a collection device which in turn communicates with the management device. That is, some implementations can combine FIGS. 2A and 2B.

FIG. 3 is a schematic diagram showing an exemplary system 300 for collecting teleoperation data and human data. FIG. 3 includes system 100 as discussed earlier with reference to FIG. 1, which is responsible for capturing teleoperation data including robot data and pilot data as previously discussed. FIG. 3 also includes system 200, which is analogous to systems 200a and 200b discussed earlier with reference to FIGS. 2A and 2B, and is responsible for capturing human data as previously discussed.

FIG. 3 includes a management device 310, which receives the teleoperation data from system 100 and the human data from system 200. Management device 310 includes a communication interface 312, at least one processor 314 and at least one non-transitory processor-readable storage medium 316. Management device 310 can in some implementations be implemented in a distributed manner, where the components thereof are spread across multiple devices (e.g. in a cloud or network environment). Further, management device 310 can in some implementations include a plurality of processors and/or a plurality of non-transitory processor-readable storage mediums distributed across a plurality of devices. In an example, management device 310 could include two or more devices. In this example, one device includes the communication interface 312 and a medium of the at least one non-transitory processor-readable storage medium 316, for receiving and storing the teleoperation data and the human data. Another device includes the at least one processor 314, and accesses or requests the stored teleoperation data and human data, to perform method 400 discussed below.

In some implementations, the teleoperation data is communicated from system 100 to management device 310 via network 301 (shown as communication pathways 302 and 306 in FIG. 3). In particular, a communication interface of the teleoperation system 170 (e.g. wireless transceiver 171) transmits the teleoperation data to a communication network such as a cellular or internet network, which in turn transmits the teleoperation data to communication interface 312 of management device 310.

In some implementations, the teleoperation data is communicated directly from system 100 to management device 310 (shown as communication pathway 304 in FIG. 3). In particular, a communication interface of the teleoperation system 170 (e.g. wireless transceiver 171) transmits the teleoperation data to communication interface 312 of management device. Communication pathway 304 can be wired or wireless.

In some implementations, the human data is communicated from system 200 to management device 310 via network 301 (shown as communication pathways 303 and 306 in FIG. 3). In particular, a communication interface of the system 200 (e.g. communication interfaces 250a, 250b, or 271) transmits the human data to a communication network such as a cellular or internet network, which in turn transmits the human data to communication interface 312 of management device 310.

In some implementations, the human data is communicated directly from system 200 to management device 310 (shown as communication pathway 305 in FIG. 3). In particular, a communication interface of system 200 (e.g. communication interfaces 250a, 250b, or 271) transmits the human data to communication interface 312 of management device. Communication pathway 305 can be wired or wireless.

In some implementations, the teleoperation system 170 in FIG. 1 and the management device 310 are the same device (or collection of devices). In such implementations, the teleoperation data is received at the teleoperation system 170/management device 310 as described with reference to FIG. 1. The human data is transmitted from system 200 to management device 310 (as teleoperation system 170) as described with reference to FIG. 3.

In some implementations, the management device 270 and the management device 310 are the same device (or collection of devices). In such implementations, the human data is received at the management device 270/310 as described with reference to FIGS. 2A and 2B. The teleoperation data is transmitted from the teleoperation system 170 to management device 270/310 as described with reference to FIG. 3.

The teleoperation data and the human data are received at the management device 310 (or equivalent in certain implementations, such as teleoperation system 170 or management device 270), for use in method 400 described below with reference to FIG. 4. In some cases, the teleoperation data and human data are stored in the at least one non-transitory processor-readable storage medium 316, for subsequent access in the context of method 400. In other cases, the teleoperation data and the human data can be stored at a separate device (e.g. a network storage device) accessible to the management device 310.

FIG. 4 is a flow diagram showing an exemplary method 400 of accessing training data and training at least one foundation model. Method 400 can in in general be performed by a management device, using data collected from teleoperation and human data collection systems as discussed earlier. For example, the at least one non-transitory processor-readable storage medium 316 of management device 310 in FIG. 3 can store processor-executable instructions or data which when executed by the at least one processor 314 cause the management device 310 to perform method 400. In implementations where another device fulfills the management device role, such as teleoperation system 170 in FIG. 1 or management device 270 in FIGS. 2A and 2B as options discussed earlier, can also execute processor-executable instructions which cause them to perform method 400. Further, a method of training a foundation model such as method 400 can be implemented as a computer program product. Such a computer program product comprises processor-executable instructions or data that, when the computer program product is stored on a non-transitory processor-readable storage medium (such as medium 316 of management device 310), and the computer program product is executed by at least one processor (such as processor 314 of management device 314), the computer program product (or the processor-executable instructions or data thereof) cause the device (e.g. management device 310) to perform acts of the method.

Method 400 as illustrated includes acts 410, 420, 430 (which includes a subset of acts 431, 432, 433, 434, and 435), and 440 though those of skill in the art will appreciate that in alternative implementations certain acts may be omitted and/or additional acts may be added. For example, act 440 is illustrated in dashed lines to highlight that this act is optional. Further, acts 431 and 432, acts 433 and 434, and acts 435 are alternative options.

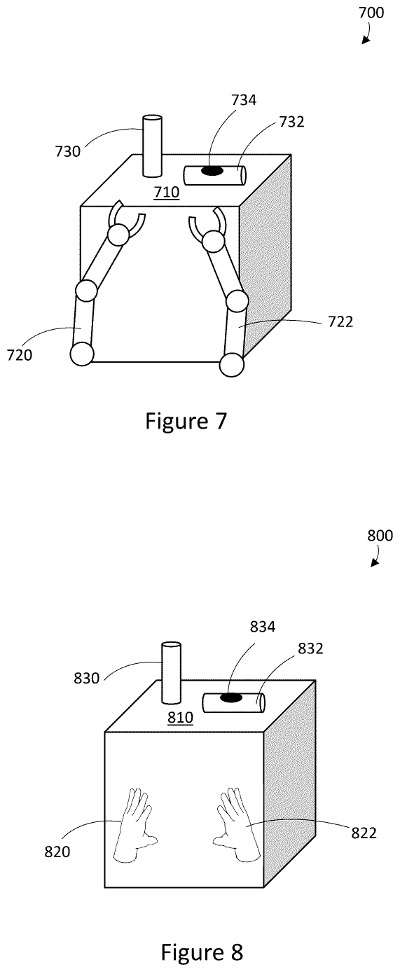

In this disclosure, a foundation model is trained to perform a “task”, based on teleoperation data of a pilot/robot performing the task, and based on human data of a human performing the task. In this context, the “task” refers to a particular objective, motion, operation, or sequence which is desired to be completed. One exemplary task is discussed later with reference to FIGS. 7 and 8, but the present disclosure applies to any number or type of different tasks.

At 410, at least one instance of teleoperation data is accessed. The teleoperation data includes pilot data 412 and robot data 414. The pilot data 412 is data collected by a first at least one sensor of a human piloted teleoperation system, where a human pilot provides at least one input to cause a robot to perform a task, such as teleoperation system 170 discussed earlier with reference to FIG. 1. The robot data 414 is collected by a second at least one sensor of the robot and represents operation or movement of the robot which performs the task. The robot data 414 can for example be collected by any of sensors 103, 120a, 120b, the haptic sensors on robotic hands 102a and 102b, or any other appropriate sensors of robot 100 discussed earlier with reference to FIG. 1.

In some implementations, accessing the teleoperation data as in act 410 includes capturing of the teleoperation data; that is the first at least one sensor capturing the pilot data and/or the second at least one sensor capturing the robot data are included in the scope of the method 400. In other implementations, accessing the teleoperation data as in act 410 includes receiving, but not capturing, the teleoperation data. In particular, outside of the scope of method 400, the first at least one sensor captures the pilot data 412 and the second at least one sensor captures the robot data 414, and the pilot data 412 and robot data 414 are transmitted to the device which performs method 400. In these implementations reception of this captured teleoperation data constitutes accessing the teleoperation data in act 410. In yet other implementations, accessing the teleoperation data as in act 410 includes retrieving, but not capturing, the teleoperation data. In particular, outside of the scope of method 400, the first at least one sensor captures the pilot data 412 and the second at least one sensor captures the robot data 414, and the pilot data 412 and robot data 414 are transmitted to a storage device (e.g. a database or non-transitory processor-readable storage medium). In these implementations, accessing the teleoperation data in act 410 comprises retrieving or receiving the teleoperation data from storage.

The teleoperation data includes at least one instance of data. In particular, each “instance” of the at least one instance of teleoperation data corresponds to a single execution of the task by the pilot and robot. In particular, the pilot performs the task a particular time, and the teleoperation system causes the robot to perform the task in accordance with the input data from the pilot. The data captured for this particular execution of the task is one “instance” of teleoperation data. The pilot and robot can perform the task a plurality of times, with teleoperation data for each execution of the task being collected as a respective “instance” of teleoperation data. In this way, a plurality of instances of teleoperation data can be collected as the “at least one instance” of teleoperation data. In some implementations, where the at least one instance of teleoperation data comprises a plurality of instances of teleoperation data, each instance of teleoperation data can be collected for the same teleoperation system (i.e. the same teleoperation system is piloted to cause the same robot to execute the task a plurality of times). In other implementations, where the at least one instance of teleoperation data comprises a plurality of instances of teleoperation data, the plurality of instances of teleoperation data can be collected for a plurality of different teleoperation systems (i.e. more than one teleoperation system is piloted to cause more than one robot to execute the task). In implementations where the plurality of instances of teleoperation data are collected for a plurality of different teleoperation systems, each teleoperation system may still collect a plurality of instances of teleoperation data (each teleoperation system may perform the task any number of times).

In some implementations, the robot data can be collected for at least one simulated robot. FIG. 5 is an illustrative diagram showing an exemplary simulated environment 500 in which a plurality of robots a simulated. Simulated environment 500 includes a simple space having a flat ground 501 and is not based on any real-world space (though it could be). Multiple simulated instances of a real-world robot are present in simulated environment 500 (thought the simulation could be limited to a single robot, if appropriate). An exemplary first simulated robot 510 is shown, performing a task at surface 511; an exemplary second simulated robot 520 is shown, performing a task at surface 521; and an exemplary third simulated robot 530 is shown, performing a task at surface 531. More simulated robots are shown in FIG. 5, but only these three are called out in FIG. 5 to reduce clutter.

A simulation engine can simulate sensors or sensor data for the robots. That is, the simulated robots are moved in accordance with pilot data, and the simulation engine generates sensor data which emulates real world sensor data collected by real world robots.

In some implementations, each robot can be simulated to perform a task based on respective pilot data collected from a respective human pilot via a teleoperation system. That is, there is a one-to-one relationship between each pilot and each simulated robot. In such implementations, physical robots are not required, and thus costs are reduced by requiring less hardware, reducing wear-and-tear and maintenance on hardware. However, labor costs are still high because a significant amount of pilot time is required for the necessary pilot data.

In some implementations, pilot data collected from a human pilot via a teleoperation system can be used in the simulation of a plurality of robots. That is, there is a one-to-many relationship between each pilot and each simulated robot. In particular, domain expansion techniques can be used on the pilot data, to expand the amount and diversity of pilot data. For example, noise, distortions, or other variations can be applied to the pilot data to produced diversified copies of the pilot data. These diversified copies of the pilot data can then be used to control simulation of respective simulated robots. In this way, teleoperation data can be collected for a great number of robots, with a reduced labor cost for collecting pilot data because less pilots and/or less pilot time is required.

Returning to method 400 in FIG. 4, at 420, at least one instance of human data 422 is accessed. The human data 422 is data collected by a third at least one sensor of a human data-collection system, such as systems 200a and 200b discussed earlier with reference to FIGS. 2A and 2B. Each instance of the human data 422 represents a human performing the task. The human data 422 can for example be collected by any of sensors 205a, 205b, 220a, 220b, 221a, 222a, 223a, 224a, 225a, or any other appropriate sensor of systems 200a and/or system 200b in FIG. 2A or 2B discussed earlier.

In some implementations, accessing the at least one instance of human data 422 as in act 420 includes capturing of the human data. That is, the third at least one sensor capturing the human data is included in the scope of the method 400. In other implementations, accessing the human data 422 as in act 420 includes receiving, but not capturing, the human data 422. In particular, outside of the scope of method 400, the third at least one sensor captures the human data 422, and the human data 422 is transmitted to the device which performs method 400. In these implementations reception of this captured human data constitutes accessing the human data 422 in act 420. In yet other implementations, accessing the human data 422 as in act 420 includes retrieving, but not capturing, the human data. In particular, outside of the scope of method 400, the third at least one sensor captures the human data 422, and the human data 422 is transmitted to a storage device (e.g. a database or non-transitory processor-readable storage medium). In these implementations, accessing the human data 422 in act 420 comprises retrieving or receiving the human data 422 from storage.

The human data 422 includes at least one instance of data. In particular, each “instance” of the at least one instance of human data corresponds to a single execution of the task by a human. In particular, a human performs the task a particular time; the data captured for this particular execution of the task is one “instance” of human data. At least one human can perform the task a plurality of times, with human data for each execution of the task being collected as a respective “instance” of human data. In this way, a plurality of instances of human data can be collected as the “at least one instance” of human data.

In some implementations, where the at least one instance of human data comprises a plurality of instances of human data, each instance of human data can be collected for a single human performing the task. By performing the task a plurality of times, a plurality of instances of human data can be collected, one instance of human data being collected per each time the human performs the task.

In other implementations, where the at least one instance of human data comprises a plurality of instances of human data, a plurality of humans can perform the task. In this way, a plurality of instances of human data can be collected, one instance for each time a human performs the task. Each human of the plurality of humans can perform the task a plurality of times, and thus the plurality of instances of human data can exceed the number of humans in the plurality of humans.

FIG. 6 illustrates and exemplary scenario 600 where a plurality of humans perform a task, wearing appropriate sensors for the collection of human data as discussed with reference to FIGS. 2A, 2B and 3. In particular, a human 610 is positioned proximate surface 611 to perform a task, a human 620 is positioned proximate surface 621 to perform the task, a human 630 is positioned proximate surface 631 to perform the task, a human 640 is positioned proximate surface 641 to perform the task, a human 650 is positioned proximate surface 651 to perform the task, and a human 660 is positioned proximate surface 661 to perform the task. While six humans are illustrated in FIG. 6, human data can be collected for any appropriate number of humans. The humans in FIG. 6 could for example be workers in a factory who work at respective stations (represented by surfaces 611, 621, 631, 641, 651, and 661) to produce a product. Each time any of humans 610, 620, 630, 640, 650, or 660 performs a particular task, human data is collected by the at least one sensor worn by the respective human, the human data representing the human performing the task. Thus, each time any of humans 610, 620,630, 640, 650, or 660 performs the particular task, and instance of human data is collected representing the task being performed.

As discussed earlier, collection of teleoperation data is time consuming and expensive. Further, performing teleoperation to generate data used to train a model is commonly not productive apart from the training data generated. That is, the teleoperation is commonly not used to actually get tasks done, but rather is used to show the robot how to do tasks. By collecting human data from at least one human actually performing the task, real-world productivity is achieved while the training data (as human data) is collected. This significantly reduces the cost associated with collecting the training data, since the costs are offset by actual productivity achieved. Further, there are commonly many more humans performing a particular task than there are available teleoperation systems and robots to generate training data. Consequently, many more instances of human data can be collected compared to instances of teleoperation data.

Returning to method 400 in FIG. 4, at 440 at least one instance of object parameter data 442 can optionally be accessed in some implementations. This parameter data is discussed in more detail later with reference to FIGS. 7 and 8.

At 430, the at least one processor of the device (e.g. the at least one processor 314 of management device 310) which performs method 400 trains at least one foundation model based on the at least one instance of teleoperation data. Example details related to training foundation models that may be employed in some implementations of the present systems, devices, methods, and computer program products are described in U.S. patent application Ser. Nos. 18/598,038, 17/495,544, and/or 17/566,601, each of which is incorporated herein by reference in its entirety. In FIG. 4, three alternative implementations are described for training the at least one foundation model: a first implementation including acts 431 and 432, a second implementation including acts 433 and 434, and a third implementation including act 435.

In the first implementation, a first foundation model is trained based on the teleoperation data at 431. Subsequently, the first foundation model is refined based on the human data at 432. Refining the first foundation model at 432 produces a second foundation model.

In the second implementation, a first foundation model is trained based on the human data at 433. Subsequently, the first foundation model is refined based on the teleoperation data at 434. Refining the first foundation model at 434 produces a second foundation model.

In the third implementation, a single foundation model is trained based on the teleoperation data and the human data together at 435.

In some implementations, training the foundation model at 430 (regardless of which implementation is used to train the foundation model) comprises training the foundation model to include at least one action command which when executed causes the robot to attempt to perform the task. For example, the trained foundation model can comprise at least one instruction which when executed by a robot controller of the robot cause at least one actuatable member of the robot to move to attempt to perform the task. As another example, the foundation model can include at least one movement path for at least one actuatable member of the robot to attempt to perform the task.

In some implementations, for each instance of the at least one instance of teleoperation data, the collected robot data (by at least one sensor of the robot) represents operation of the robot which performs a task including engaging with a first set of at least one object. An illustrative example is shown in FIG. 7.

FIG. 7 is a perspective diagram of a scenario 700 from a point of view of a robot (an egocentric view from an image sensor of the robot such as sensor 103 in FIG. 1). FIG. 7 shows a work surface 710 with objects 730 and 732 placed thereon. Object 732 has a hole 734 for receiving object 730. FIG. 7 also shows actuatable components (arms, in the example) 720 and 722 of the robot. In the exemplary scenario 700 of FIG. 7, the robot is to perform a task involving inserting object 730 into the hole 734 of object 732. In this example, the first set of at least one object includes object 730 and object 732; though in other examples any appropriate number of objects could be included.

Further, there is generally a correspondence between a task performed by the robot when collecting the robot data and the task performed by a human when collecting human data. As such, for each instance of the at least one instance of human data, the collected human data (by at least one sensor positioned at the human) represents the human performing the task including engaging with a second set of at least one object which corresponds to the first set of at least one object. An illustrative example is shown in FIG. 8.

FIG. 8 is a perspective diagram of a scenario 800 from a point of view of a human (an egocentric view from an image sensor worn by the human, such as image capture devices 203 or 204 in FIGS. 2A and 2B). FIG. 8 shows a work surface 810 with objects 830 and 832 placed thereon. Object 832 has a hole 834 for receiving object 830. FIG. 8 also shows hands 820 and 822 of the human. In the exemplary scenario 800 of FIG. 8, the human is to complete a task involving inserting object 830 into the hole 834 of object 832. In this example, the second set of at least one object includes object 830 and object 832; though in other examples any appropriate number of objects could be included.

In some implementations, the first set of at least one object is the second set of at least one object; that is, the first set of at least one object and the second set of at least one object are the same set of at least one objects. The robot data can be collected by having at least one robot perform the task with the set of at least one object, and the human data can be collected by having the at least one human perform the task with the set of at least one object (at a different time). With reference to the example of FIGS. 7 and 8, the robot can perform the task of inserting object 730 into hole 734 of object 732 any appropriate number of times to collect at least one instance of robot data. Separately (before or after the robot), at least one human can perform the task of inserting object 830 (which is object 730 in this example) into hole 834 of object 832 (which is hole 734 of object 732 in this example).

In some implementations, the first set of at least one object matches the second set of at least one object, but is not actually the same at least one object. For example, the first set of at least one object and the second set of at least one objects could be corresponding objects which are produced to be approximately identical (e.g., multiple objects produced in bulk manufacturing). With reference to the example of FIGS. 7 and 8, the robot can perform the task of inserting object 730 into hole 734 of object 732 any appropriate number of times to collect at least one instance of robot data. Separately or concurrently, at least one human can perform the task of inserting object 830 into hole 834 of object 832. Because the objects 730 and 732 match the object 830 and 832 in this implementation, the collected robot data and human data effectively represents performing the same task on “the same” set of at least one object, even though the objects are not actually “the same” set of objects.

In further implementations, multiple robots can perform the task with multiple sets of at least one matching object, and likewise multiple humans can perform the task with multiple sets of at least one matching object. In this way, a significant quantity of robot data and or human data can be collected without being restricted by a limited quantity of objects to interact with.

In some implementations, parameter data for objects (the first set of at least one object and/or the second set of at least one object) can be accessed in the context of method 400 in FIG. 4 (shown at 440 in method 400). Parameter data for any particular object can specify any appropriate parameters (indicative of aspects, attributes, or features) of the object. Non-limiting exemplary parameters could include dimensions, weight, density, surface texture, or resilience of the object itself, or of features of the object (e.g. of hole 734 in object 732). In some implementations, the parameter data can specify attributes by labels or numerals (e.g. a table of attributes or properties). In some implementations, the parameter data can include models (such as three-dimensional CAD models or scans) of the object.

Parameter data could be collected in a variety of ways, such as manual measurement and recordation, by scanning objects (e.g. with a laser or other type of scanner), or by maintaining model documentation used in creation of the objects. In some implementations, accessing the parameter data 442 at 440 in method 400 comprises retrieving or receiving the parameter data 442 from a parameter data storage location (e.g. a database). For example, parameter data can be stored at non-transitory processor-readable storage medium 316 of management device 310, or could be stored at a network storage device accessible to management device 310.

Where parameter data 442 is accessed at 440, training of the at least one foundation model at 430 comprises training the foundation model based on the at least one instance of teleoperation data (pilot data 412 and robot data 414), the at least one instance of human data 422, and the parameter data 442.

In some implementations, the parameter data is used together with the teleoperation data and/or the human data during respective steps. In an example, training the first foundation model at 431 can comprise training the first foundation model based on the at least one instance of teleoperation data and the parameter data; further, refining the first foundation model at 432 can comprises refining the first foundation model based on the at least one instance of human data 422 and the parameter data 442 to produce the second foundation model. In another example, training the first foundation model at 433 can comprise training the first foundation model based on the at least one instance of human data 422 and the parameter data; further, refining the first foundation model at 434 can comprise refining the first foundation model based on the at least one instance of teleoperation data and the parameter data 442 to produce the second foundation model.

In some implementations, the parameter data, teleoperation data, and human data are all used together to train a single foundation model. In particular, training the single foundation model at 435 can comprise training the single foundation model based on the teleoperation data, the human data 422, and the parameter data 442.

The systems, methods, and computer program products described herein may, in some implementations, employ any of the teachings of the present systems, methods, control modules, and computer program products include, without limitation, the general-purpose humanoid robots developed by Sanctuary Cognitive Systems Corporation, various aspects of which are described in U.S. patent application Ser. Nos. 18/375,943, 18/513,440, 18/417,081, 18/424,551, 16/940,566 (Publication No. U.S. 2021-0031383 A1), U.S. patent application Ser. No. 17/023,929 (Publication No. U.S. 2021-0090201 A1), U.S. patent application Ser. No. 17/061,187 (Publication No. U.S. 2021-0122035 A1), U.S. patent application Ser. No. 17/098,716 (Publication No. U.S. 2021-0146553 A1), U.S. patent application Ser. No. 17/111,789 (Publication No. U.S. 2021-0170607 A1), U.S. patent application Ser. No. 17/158,244 (Publication No. U.S. 2021-0234997 A1), US Provisional Patent Application Ser. No. 63/001,755 (Publication No. U.S. 2021-0307170 A1), and/or U.S. Provisional Patent Application Ser. No. 63/057,461, as well as U.S. Provisional Patent Application Ser. No. 63/151,044, U.S. Provisional Patent Application Ser. No. 63/173,670, U.S. Provisional Patent Application Ser. No. 63/184,268, U.S. Provisional Patent Application Ser. No. 63/213,385, U.S. Provisional Patent Application Ser. No. 63/232,694, U.S. Provisional Patent Application Ser. No. 63/316,693, U.S. Provisional Patent Application Ser. No. 63/253,591, U.S. Provisional Patent Application Ser. No. 63/293,968, U.S. Provisional Patent Application Ser. No. 63/293,973, and/or U.S. Provisional Patent Application Ser. No. 63/278,817, each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method comprising:
accessing at least one instance of teleoperation data, each instance of the at least one instance of teleoperation data comprising:
pilot data, the pilot data collected by a first at least one sensor of a piloted teleoperation system where a pilot provides at least one input to cause a robot to perform a task;
robot data, the robot data collected by a second at least one sensor of the robot and representing operation of the robot which performs the task;
accessing at least one instance of human data, each instance of the at least one instance of human data comprising data collected by a third at least one sensor positioned at a human and representing the human performing the task; and
training at least one model based on the at least one instance of teleoperation data and the at least one instance of human data.

2. The method of claim 1, wherein training at least one model based on the at least one instance of teleoperation data and the at least one instance of human data comprises:
training a first model based on the at least one instance of teleoperation data; and
refining the first model based on the at least one instance of human data to produce a second model.

3. The method of claim 1, wherein training at least one model based on the at least one instance of teleoperation data and the at least one instance of human data comprises:
training a first model based on the at least one instance of human data; and
refining the first model based on the at least one instance of teleoperation data to produce a second model.

4. The method of claim 1, wherein training at least one model based on the at least one instance of teleoperation data and the at least one instance of human data comprises:
training a single model based on the at least one instance of teleoperation data and the at least one instance of human data.

5. The method of claim 1, wherein:
accessing the at least one instance of teleoperation data comprises, for each instance of the teleoperation data, capturing, by at least one image sensor of the second at least one sensor as worn by the robot and aligned with a perspective of the robot, at least a portion of the robot data as robot-centric image data including a visual representation of the robot performing the task; and
accessing the at least one instance of human data comprises, for each instance of the human data, capturing, by at least one image sensor of the third at least one sensor as worn by the human and aligned with a perspective of the at least one human, at least a portion of the human data as human-centric image data including a visual representation of the at least one human performing the task.

6. The method of claim 1, wherein:
accessing the at least one instance of teleoperation data comprises, for each instance of the teleoperation data, capturing, by at least one inertial sensor of the second at least one sensor, at least a portion of the robot data as inertial data including an inertial representation of the robot performing the task; and
accessing the human data comprises, for each instance of the human data, capturing, by at least one inertial sensor of the third at least one sensor, at least a portion of the human data as inertial data including an inertial representation of the human performing the task.

7. The method of claim 1, wherein:
accessing the at least one instance of teleoperation data comprises, for each instance of the teleoperation data, capturing, by at least one haptic sensor of the second at least one sensor, at least a portion of the robot data as haptic data including a haptic representation of the robot performing the task; and
accessing the at least one instance of human data comprises, for each instance of the human data, capturing, by at least one haptic sensor of the third at least one sensor, at least a portion of the human data as haptic data including a haptic representation of the human performing the task.

8. The method of claim 1, wherein accessing the at least one instance of teleoperation data comprises generating, by at least one processor, at least a portion of the robot data as simulated sensor data representing motion or physical contact of a simulated instance of the robot controlled in accordance with the pilot data to perform the task.

9. The method of claim 1, wherein:
the at least one instance of teleoperation data includes a first quantity of instances; and
the at least one instance of human data includes a second quantity of instances greater than the first quantity of instances.

10. The method of claim 1, wherein:
for each instance of the at least one instance of teleoperation data, the robot data represents operation of the robot which performs the task including engaging with a first set of at least one object; and
for each instance of the at least one instance of human data, the human data represents the human performing the task including engaging with a second set of at least one object which corresponds to the first set of at least one object.

11. A system comprising:
at least one processor; and
at least one non-transitory processor-readable storage medium communicatively coupled to the at least one processor, the at least on non-transitory processor-readable storage medium storing processor-executable instructions which, when executed by the at least one processor, cause the system to:
access at least one instance of teleoperation data, each instance of the at least one instance of teleoperation data comprising:
pilot data, the pilot data collected by a first at least one sensor of a piloted teleoperation system where a pilot provides at least one input to cause a robot to perform a task;
robot data, the robot data collected by a second at least one sensor of the robot and representing operation of the robot which performs the task;
access at least one instance of human data, each instance of the at least one instance of human data comprising data collected by a third at least one sensor positioned at a human and representing the human performing the task; and
train, by the at least one processor, at least one model based on the at least one instance of teleoperation data and the at least one instance of human data.

12. The system of claim 11, wherein the processor-executable instructions which cause the at least one processor to train at least one model based on the at least one instance of teleoperation data and the at least one instance of human data cause the at least one processor to:
train a first model based on the at least one instance of teleoperation data; and
refine the first model based on the at least one instance of human data to produce a second model.

13. The system of claim 11, wherein the processor-executable instructions which cause the at least one processor to train at least one model based on the at least one instance of teleoperation data and the at least one instance of human data cause the at least one processor to:
train a first model based on the at least one instance of human data; and
refine the first model based on the at least one instance of teleoperation data to produce a second model.

14. The system of claim 11, wherein the processor-executable instructions which cause the at least one processor to train at least one model based on the at least one instance of teleoperation data and the at least one instance of human data cause the at least one processor to:
train a single model based on the at least one instance of teleoperation data and the at least one instance of human data.

15. The system of claim 11, further comprising:
at least one image sensor of the second at least one sensor worn by the robot and aligned with a perspective of the robot; and
at least one image sensor of the third at least one sensor worn by the human and aligned with a perspective of the at least one human, wherein
the processor-executable instructions which cause the system to access the at least one instance of teleoperation data cause the at least one image sensor of the second at least one sensor to capture at least a portion of the robot data as robot-centric image data including a visual representation of the robot performing the task; and
the processor-executable instructions which cause the system to access the at least one instance of human data cause the at least one image sensor of the third at least one sensor to capture at least a portion of the at least one instance of human data as human-centric image data including a visual representation of the human performing the task.

16. The system of claim 11, further comprising:
at least one inertial sensor of the second at least one sensor: and
at least one inertial sensor of the third at least one sensor, wherein
the processor-executable instructions which cause the system to access the at least one instance of teleoperation data cause the at least one inertial sensor of the second at least one sensor to capture at least a portion of the robot data as inertial data including an inertial representation of the robot performing the task; and
the processor-executable instructions which cause the system to access the at least one instance of human data cause the at least one inertial sensor of the third at least one sensor to capture at least a portion of the at least one instance of human data as inertial data including an inertial representation of the human performing the task.

17. The system of claim 11, further comprising:
at least one haptic sensor of the second at least one sensor: and
at least one haptic sensor of the third at least one sensor, wherein
the processor-executable instructions which cause the system to access the at least one instance of teleoperation data cause the at least one haptic sensor of the second at least one sensor to capture at least a portion of the robot data as haptic data including a haptic representation of the robot performing the task; and
the processor-executable instructions which cause the system to access the at least one instance of human data cause the at least one haptic sensor of the third at least one sensor to capture at least a portion of the at least one instance of human data as haptic data including a haptic representation of the human performing the task.

18. The system of claim 11, wherein the processor-executable instructions which cause the system to access the at least one instance of teleoperation data cause the at least one processor to generate at least a portion of the robot data as simulated sensor data representing motion or physical contact of a simulated instance of the robot controlled in accordance with the pilot data to perform the task.

19. The system of claim 11, wherein:
the at least one instance of teleoperation data includes a first quantity of instances; and
the at least one instance of human data includes a second quantity of instances greater than the first quantity of instances.

20. The system of claim 11, wherein:
for each instance of the at least one instance of teleoperation data, the robot data represents operation of the robot which performs the task including engaging with a first set of at least one object; and
for each instance of the at least one instance of human data, the human data represents the human performing the task including engaging with a second set of at least one object which corresponds to the first set of at least one object.
